(19) United States
(12) Patent Application Publication
(10) Pub. No.: US 2016/0053804 A1
(43) Pub. Date: Feb. 25, 2016

(54) DUST COVER FOR BALL JOINT

(71) Applicant: NOK CORPORATION, Tokyo (JP)

(72) Inventors: Takayoshi IWASAKA, Makinohara (JP); Junichi ISHIMORI, Makinohara (JP); Toshikazu KUMAZAWA, Makinohara (JP); Hiroshi SUZUKI, Makinohara-shi, Shizuoka (JP)

(21) Appl. No.: 14/782,747

(22) PCT Filed: May 15, 2014
(86) PCT No.: PCT/JP2014/062903

§ 371 Date: Oct. 6, 2015

(30) Foreign Application Priority Data
May 28, 2013 (JP) 2013-111528

(51) Int. Cl. F16C 11/06

(52) U.S. Cl. CPC F16C 11/0671

(57) ABSTRACT

A dust cover for a ball joint is structured such that a spherical head portion formed in one end of a ball stud is retained within a socket, a shaft in the other end of the ball stud is fastened and fixed to a knuckle, a one end large-diameter opening portion having an embedded reinforcing ring is fixed and retained to an outer peripheral surface of the socket, the other end small-diameter opening portion having an embedded reinforcing ring is retained to the shaft, a film portion connecting the large-diameter opening portion and the small-diameter opening portion is provided, and the dust cover is made of an elastic material. A maximum inner diameter of the film portion is larger than an inner diameter of the reinforcing ring which is embedded in the one end large-diameter opening portion. Therefore, a functional advantage and an assembling advantage can be provided.

### CROSS-REFERENCE TO RELATED APPLICATIONS

This application is a U.S. National Phase Application under 35 U.S.C. 371 of International Application No. PCT/JP2014/062903, filed on May 15, 2014 and published in Japanese as WO 2014/192548 Al on Dec. 4, 2014. This application claims priority to Japanese Patent Application No. 2013-111528, filed on May 28, 2013. The entire disclosures of the above applications are incorporated herein by reference.

### BACKGROUND OF THE INVENTION

1. Field of the Invention

The present invention relates to a dust cover for a ball joint.

Further, the present invention relates to a dust cover for a ball joint which is used in an automobile suspension device, and a steering device.

2. Description of the Conventional Art

Conventionally, as a ball joint to which a dust cover is installed for the purpose of a dust prevention and a water prevention in a ball joint coupling portion, there has been known a dust cover for a ball joint which is described in FIG. 4 (Japanese Unexamined Patent Publication No. 62-137408).

In a seal structure of this kind of ball joint dust cover, a spherical head portion 200 formed in one end of a ball stud 100 is retained within a socket 300.

Further, a shaft 400 in the other end of the ball stud 100 is fastened and fixed to a knuckle 500.

On the other hand, a one end large-diameter opening portion 800 of a dust cover 600 made of a rubber-like elastic material is fitted and retained to a step portion 310 which is formed in an outer peripheral surface of the socket 300 by a retention annular pressure ring 700, and the other end small-diameter opening portion 150 in which a reinforcing ring is embedded is retained to the shaft 400.

Since a film portion of this kind of conventional dust cover 600 is formed into a drum shape, the reinforcing ring could not be integrally embedded in the one end large-diameter opening portion 800 due to restrictions on molding.

Accordingly, the conventional dust cover has had trouble with an assembling property.

Consequently, in the case that the reinforcing ring is integrally embedded in the one end large-diameter opening portion 800, it is necessary to change the shape of the film portion of the dust cover 600 from the drum shape to a cylindrical shape shown in FIG. 5.

In other words, a maximum inner diameter A of a film portion 610 of the dust cover 600 made of the rubber-like elastic material is designed to be smaller than an inner diameter B of a reinforcing ring 801 which is embedded in the one end large-diameter opening portion 800.

According to the structure mentioned above, it is possible to take out an intermediate die of a molding die.

However, a strain applied to the film portion 610 of the dust cover 600 tends to be greater as a shape of the dust cover 600 comes close to a cylindrical shape, in spite of a good assembling property.

As a result, a crack or a breakage is generated in the film portion 610 of the dust cover 600, and a problem that a durability is lowered has been brought about.

Further, there has been brought about a problem that a part of a circumference of the film portion 610 of the dust cover 600 is abnormally deformed to an inner diameter side at the setting time of the dust cover 600.

### SUMMARY OF THE INVENTION

### Problem to be Solved by the Invention

The present invention is made by taking the problem mentioned above into consideration, and an object of the present invention is to provide a functional advantage and an assembling advantage by forming a film portion into a drum shape so as to hold down a strain applied to the film portion of a dust cover and suppress the reduction of a durability of the dust cover, even in an aspect in which a reinforcing ring is embedded in a one end large-diameter opening portion and the other end small-diameter opening portion of the dust cover.

### Means for Solving the Problem

A dust cover for a ball joint according to the present invention is a dust cover for a ball joint comprising:

a spherical head portion formed in one end of a ball stud, the spherical head portion being retained within a socket;

a shaft in the other end of the ball stud, the shaft being fastened and fixed to a knuckle;

a one end large-diameter opening portion having an embedded reinforcing ring, the one end large-diameter opening portion being fixed and retained to an outer peripheral surface of the socket;

the other end small-diameter opening portion having an embedded reinforcing ring, the other end small-diameter opening portion being retained to the shaft;

a film portion connecting the large-diameter opening portion and the small-diameter opening portion; and

the dust cover being made of an elastic material,

wherein a maximum inner diameter of the film portion is larger than an inner diameter of the reinforcing ring which is embedded in the one end large-diameter opening portion.

### Effect of the Invention

The present invention achieves effects described below.

According to the ball joint of the dust cover of the invention described in a first aspect, it is possible to provide a functional advantage and an assembling advantage by holding down a strain applied to the film portion of the dust cover and suppressing the reduction of a durability of the dust cover, even in an aspect in which the reinforcing ring is embedded in the one end large-diameter opening portion and the other end small-diameter opening portion of the dust cover.

Further, according to the dust cover for the ball joint of the invention described in a second aspect, it is possible to hold down the strain applied to the film portion of the dust cover and suppress the reduction of a durability of the dust cover by forming the film portion into a drum shape.

Further, according to the dust cover for the ball joint of the invention described in a third aspect, it is possible to easily mold the dust cover having the drum shaped film portion, by being constructed by a core die which is somewhat smaller than the inner diameter of the reinforcing ring, and a plurality of separated semilunar dies which form a drum shape and have a semilunar cross section, and being formed by a molding metal die which takes out these dies while sequentially disassembling the dies.

### BRIEF EXPLANATION OF THE DRAWINGS

FIG. 1 is a vertical cross sectional view of a dust cover for a ball joint according to the present invention;

FIG. 2 is a vertical cross sectional view before installation of the dust cover for the ball joint in FIG. 1;

FIG. 3 is a vertical cross sectional view showing a dimensional relationship before the installation of the dust cover for the ball joint in FIG. 1;

FIG. 4 is a vertical cross sectional view of a dust cover for a ball joint according to a prior art; and

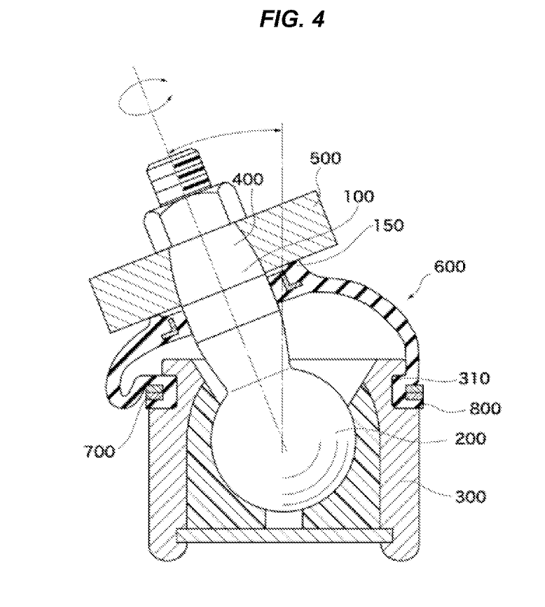

FIG. 5 is a vertical cross sectional view before installation of the other dust cover for the ball joint according to the prior art.

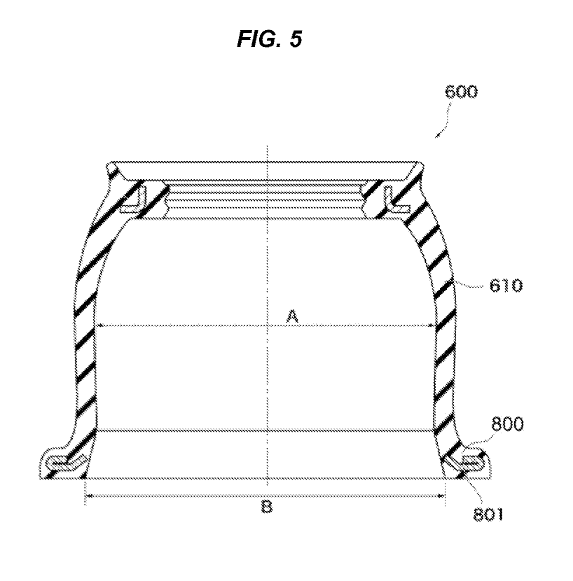

### DETAILED DESCRIPTION OF PREFERRED EMBODIMENT

A description will be given below of a mode for carrying out the present invention.

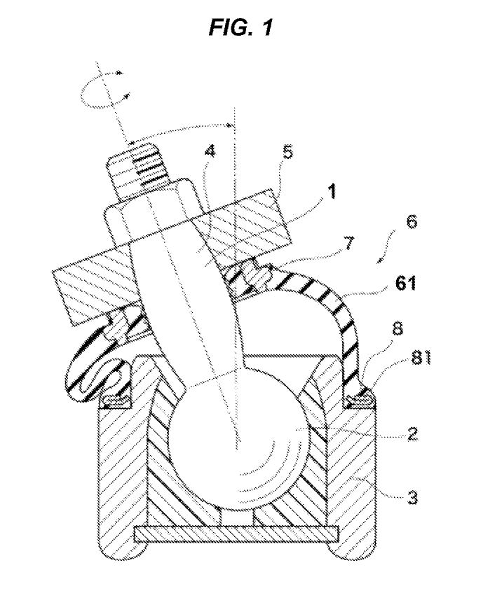

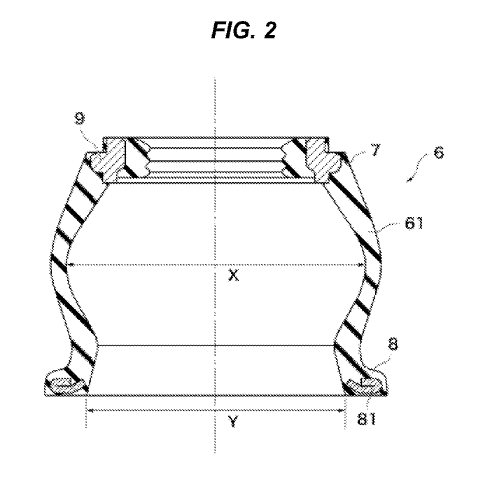

As shown in FIGS. 1 and 2, a dust cover for a ball joint according to the present invention has a basic structure in which a spherical head portion 2 molded in one end of a ball stud 1 is retained within a socket 3, a shaft 4 in the other end of the ball stud 1 is fastened and fixed to a knuckle 5, a one end large-diameter opening portion 8 having an embedded reinforcing ring 81 is fixed and retained to an outer peripheral surface of the socket 3, the other end small-diameter opening portion 7 having an embedded reinforcing ring 9 is retained to the shaft 4, and the dust cover is provided with a film portion 61 which connects the large-diameter opening portion 8 and the small-diameter opening portion 7.

Further, a maximum inner diameter X of the film portion 61 is formed to be larger than an inner diameter Y of the reinforcing ring 81 which is embedded in the one end large-diameter opening portion 8.

More specifically, the film portion 61 is formed into a drum shape, and the vicinity of the maximum inner diameter X is the thinnest.

As a result, it is possible to hold down a strain applied to the film portion of the dust cover, and it is possible to suppress the reduction of a durability of the dust cover.

Further, since the maximum inner diameter X of the film portion 61 is formed to be larger than the inner diameter Y of the reinforcing ring 81 which is embedded in the one end large-diameter opening portion 8, it is necessary to devise ways of molding.

As a specific molding method, there are a method of molding by a molding metal mold having an intermediate die and an external die, and a method of forming an unvulcanized rubber having a cylindrical film portion 61 into a drum shape by a blow molding.

However, in the case of molding by the molding metal mold, the maximum inner diameter X of the film portion 61 is formed to be larger than the inner diameter Y of the reinforcing ring 81 which is embedded in the one end large-diameter opening portion 8. As a result, it is necessary to devise ways of taking out the intermediate die from the inner portion of the molded dust cover by setting the intermediate die as the separated dies.

More specifically, it is possible to mold the dust cover by being constructed by a core die which is somewhat smaller than the inner diameter Y of the reinforcing ring 81, and a plurality of separated semilunar dies which form a drum shape and have a semilunar cross section, and taking out these dies while sequentially disassembling the dies.

Particularly, it is possible to obtain the dust cover in which a dimensional precision is good and a rubber physical property is not lowered, by molding by the molding metal mold.

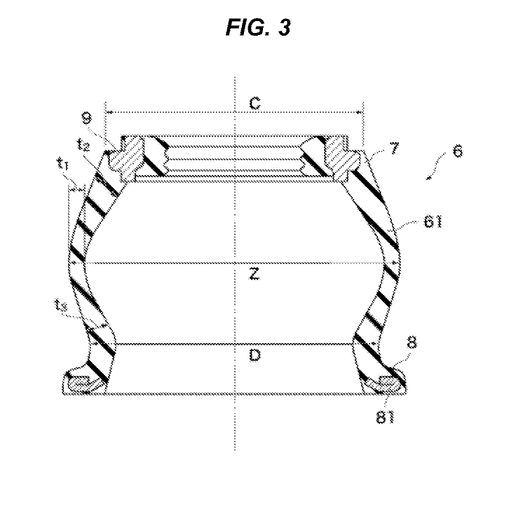

As shown in FIG. 3, the dust cover for the ball joint according to the present invention has the following dimensional relationship.

A maximum outer diameter Z of the drum shaped film portion 61 is larger than an outer diameter C in the other end small-diameter opening portion 7 side of the film portion 61 and an outer diameter D in the one end large-diameter opening portion 8 side of the film portion 61.

Further, a thickness t1 of the maximum outer diameter Z portion of the film portion 61 is formed to be thinner than a thickness t2 in the other end small-diameter opening portion 7 side of the film portion 61 and a thickness t3 in the one end large-diameter opening portion 8 side of the film portion 61.

According to the shape mentioned above, it is possible to hold down a strain applied to the film portion 61 of the dust cover 6 and it is possible to suppress the reduction of a durability of the dust cover 6.

Further, a grease is sealed into the dust cover 6.

A metal material or a resin material is used for the reinforcing ring 9 and the reinforcing ring 81, however, the reinforcing ring 81 employs a member which is manufactured by punching a steel plate such as SPCC.

Further, a material of the dust cover can be selected and used appropriately in conformity to an intended use from a rubber-like elastic material such as chloroprene and a thermoplastic elastomer such as a polyester elastomer and a thermoplastic polyurethane.

Further, it goes without saying that the present invention is not limited to the best mode for carrying out the invention mentioned above, but can employ the other various structures without deviating from the scope of the present invention.

### INDUSTRIAL APPLICABILITY

The present invention can be used in a ball joint which is used in a suspension device and a steering device of an automobile.

What is claimed is:

1. A dust cover for a ball joint comprising:
a spherical head portion (2) formed in one end of a ball stud (1), the spherical head portion being retained within a socket (3);
a shaft (4) in the other end of said ball stud (1), the shaft being fastened and fixed to a knuckle (5);
a one end large-diameter opening portion (8) having an embedded reinforcing ring (81), the one end large-diameter opening portion being fixed and retained to an outer peripheral surface of said socket (3);
the other end small-diameter opening portion (7) having an embedded reinforcing ring (9), the other end small-diameter opening portion being retained to said shaft (4);
a film portion (61) connecting said large-diameter opening portion (8) and said small-diameter opening portion (7); and
the dust cover being made of an elastic material,
wherein a maximum inner diameter (X) of said film portion (61) is larger than an inner diameter (Y) of said reinforcing ring (81) which is embedded in said one end large-diameter opening portion (8), said film portion (61) is formed into a drum shape, and said maximum inner diameter (X) portion is the thinnest, and said maximum inner diameter (X) is positioned in a center portion in an axial direction of said film portion (61).

2. (canceled)

3. The dust cover for the ball joint according to claim 1, wherein the dust cover is molded by being constructed by a core die which is somewhat smaller than the inner diameter (Y) of the reinforcing ring (81), and a plurality of separated semilunar dies which form a drum shape and have a semilunar cross section, and being formed by a molding metal die which takes out these dies while sequentially disassembling the dies.
